(19) United States
(12) Patent Application Publication
(10) Pub. No.: US 2006/0132528 A1
(43) Pub. Date: Jun. 22, 2006

(54) Method and apparatus for reducing misalignment of print on printhead

(75) Inventors: Hsiang-Pei Ou, Taichung City (TW); Chieh-Yi Huang, Hsinchu County (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/149,283

(22) Filed: Jun. 10, 2005

(30) Foreign Application Priority Data
Dec. 22, 2004 (TW) 93140054

(51) Int. Cl. B41J 29/393

(52) U.S. Cl. 347/19

(57) ABSTRACT

A print alignment method comprises detecting a skew direction of the printhead, receiving column data, corresponding to columns of printhead nozzles, dividing column data into N sections, selecting individual N column data, when the skew is to the right, the printhead receives the first section of first column data, the second section of second column data, the third section of third column data and so on; and when the skew direction is to the left, the printhead receives the Nth section of the first column data, the (N-1)th section of the second column data, the (N-2)th section of the third column data, and so on.

### BACKGROUND

The invention relates to print devices and more particularly to a printhead with an alignment compensation method and system.

In ink jet printers, ink is fed to an array of digitally controlled nozzles on a printhead. As the printhead passes over the media, ink is ejected from the array of nozzles to print on the media. Current design combines the printhead with a print cartridge. The print cartridge is then installed in the carriage of a printer, likely incurring undesirable rotation of the print cartridge which can normally skew printed lines. Correction of misalignment is thus required.

A conventional alignment method first supplies printing instructions to a printhead to energize printing elements in various groups (primitives). The printed pattern is then detected by optical sensors in the printer. Based on the detection, a position offset error for each primitive is determined. These errors generate a separate time correction for each of the primitives such that, when the printing is executed, the time period for printing a dot is advanced or delayed for each primitive so as to align the dots.

The conventional method, as described above utilizing software, can reduce print speed and require additional costs for optical sensors and other elements.

### SUMMARY

The present invention is generally directed to a print alignment method. According to one aspect of the invention, a method comprises detecting a skew direction of the printhead, receiving column data, corresponding to columns of printhead nozzles, dividing column data into N sections, selecting individual N column data, when the skew is to the right, the printhead receives the first section of first column data, the second section of second column data, the third section of third column data and so on; and when the skew direction is to the left, the printhead receives the Nth section of the first column data, the (N-1)th section of the second column data, the (N-2)th section of the third column data, and so on.

The invention further provides a print alignment method comprising detecting a skew direction of the printhead, receiving column data, corresponding to columns of printhead nozzles, dividing column data into N sections, when the skew direction is to the right, the printhead receives the first section of the column data to print and then receives the second section of the column data to print and so on in a print period (tₚ), and when the skew direction is the right, the printhead receives the Nth section of the column data to print and then receives the (N-1) th section of the column data to print and so on in a print period (tₚ).

The invention further provides a print alignment system for a printhead comprising a print module, a compensation module and a compensation print module. The print module receives print data and translates it into column data, corresponding to a plurality of columns of printhead nozzles. The compensation module receives a test pattern and outputs compensation data, comprising a skew direction and displacement offset. The compensation print module executes an alignment procedure, in accordance with the column data and the compensation data, comprising dividing column data into N sections, and selecting specific N column data, such that when the skew is to the right, the printhead receives the first section of first column data, the second section of second column data, the third section of third column and so on to print, and when the skew direction is to the left, the printhead receives the Nth section of first column, the (N-1)th section of the second column data, the (N-2)th section of third column data and so on to print.

The invention further provides a print alignment system for a printhead comprising a print module, a compensation module and a compensation print module. The print module receives print data and translates it into column data, corresponding to a plurality of columns of printhead nozzles. The compensation module receives a test pattern and outputs compensation data, comprising a skew direction and displacement offset. The compensation print module executes an alignment procedure, in accordance with the column data and the compensation data, comprising dividing column data into N sections, when the skew direction is to the right, the printhead receives and prints the first section of the column data and then receives and prints the second section of the column data and so on in a print period (tₚ), and when the skew direction is the right, the printhead receives and prints the Nth section of the column data and then receives and prints the (N-1)th section of the column data and so on in a print period (tₚ).

### BRIEF DESCRIPTION OF THE DRAWINGS

FIG. 1a is a schematic diagram of printhead skew detection.

FIG. 1b is a diagram of printhead nozzle arrangement.

FIG. 1c shows printing when a printhead is perpendicular to a moving direction.

FIG. 2 shows printing when a printhead skews to the left.

FIG. 3 is a schematic diagram of a method for alignment of the print in FIG. 2 according to embodiments of the invention.

FIG. 4 is a schematic diagram of another method for alignment of the print in FIG. 2 according to embodiments of the invention.

FIG. 5 is a schematic diagram of another method for alignment of the print in FIG. 2 according to embodiments of the invention.

FIG. 6 shows printing when a printhead skews to the right.

FIG. 7 is a schematic diagram of a method for alignment of the print in FIG. 6 according to embodiments of the invention.

FIG. 8 is a schematic diagram of another method for alignment of the print in FIG. 6 according to embodiments of the invention.

FIG. 9 is a schematic diagram of another method for alignment of the print in FIG. 6 according to another embodiment of the invention.

FIG. 10 is a functional block diagram of a system for alignment of print.

### DETAILED DESCRIPTION

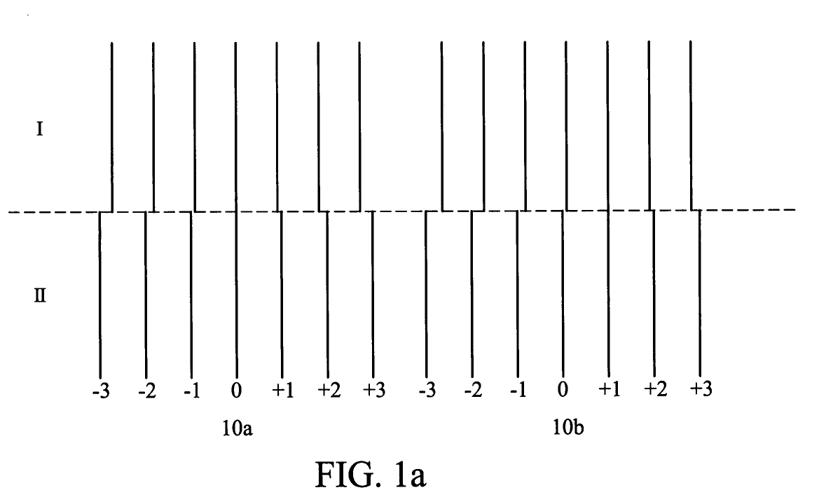

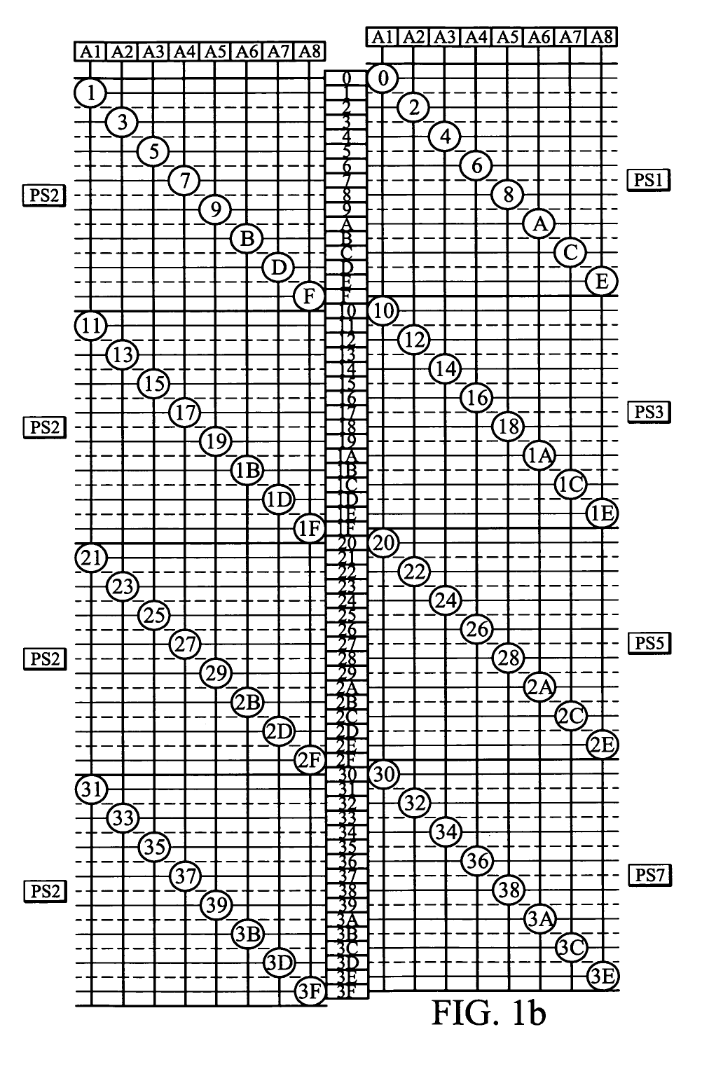

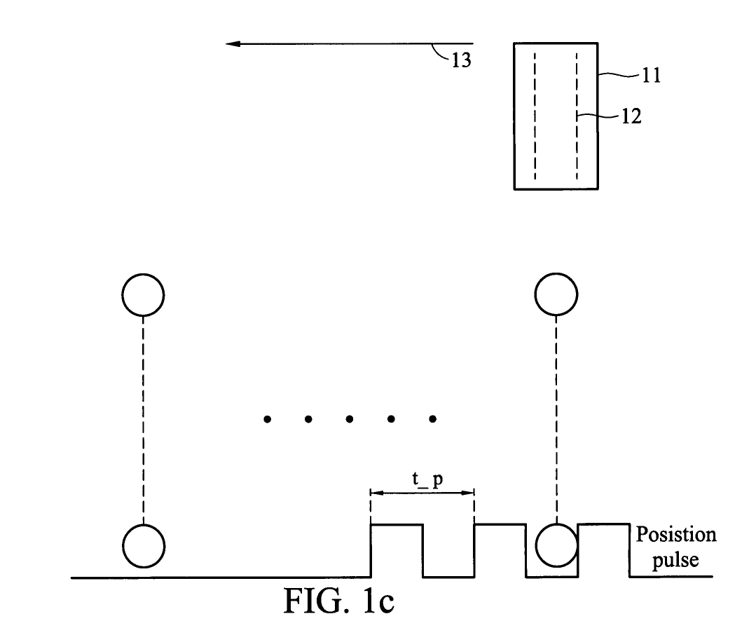

FIG. 1a is a schematic diagram of printhead skew detection. Area 10a shows printing when a printhead is perpendicular to a print bar and area lob shows printing when a printhead is not perpendicular to a print bar. Area I shows printing without any displacement offset and area II shows printing with displacement offset. In the present disclosure, the printhead receives one, two and three dpi to the right (marked as +1, +2 and +3), one, two and three dpi to the left (marked as −1, −2 and −3) and the line marked 0 represents zero displacement offset. In area 10a, the printhead is perpendicular to the print bar when lines 0 in area I and area II connect. In area lob, the printhead has one dpi displacement to the left when lines +1 in area I and area II connect. The method demonstrates skew of the printhead and displacement offset.

FIG. 1b is a diagram of printhead nozzle arrangement. 0˜3F represent nozzles. The printhead has two columns of nozzles driven by address signals A1˜A8 and primitive select signals PS1˜PS8, where the first column of nozzles is driven by address signals A1˜A8 and primitive select signals PS1, PS3, PS5 and PS7, and the second column of nozzles is driven by address signals A1˜A8 and primitive select signals PS2, PS4, PS6 and PS8. In addition, the two columns of nozzles are further divided into banks of nozzles driven by address signals A1˜A8 and primitive a select signal. When the printhead starts to print, address signals A1˜A8 are sequentially asserted and the nozzle outputs ink if the corresponding primitive select signal is asserted.

FIG. 1c shows printing when a printhead is perpendicular to a moving direction. When each nozzle outputs ink in a position pulse, the printing is a straight line, and each time period of one position pulse is t_p. The following embodiments illustrate printhead 11 using two columns of nozzles 12.

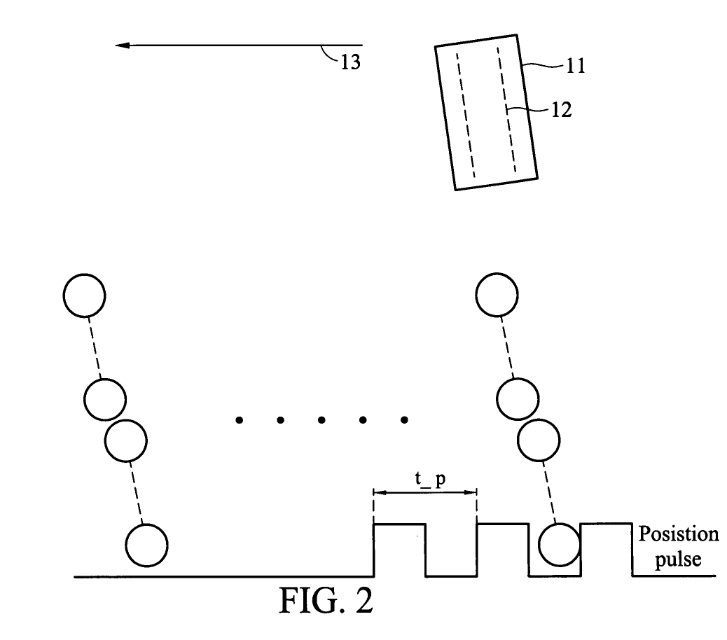

FIG. 2 shows printing when a printhead skews to the left. When each nozzle of column 12 outputs ink in a position pulse, the printing is a straight line skewed to the left.

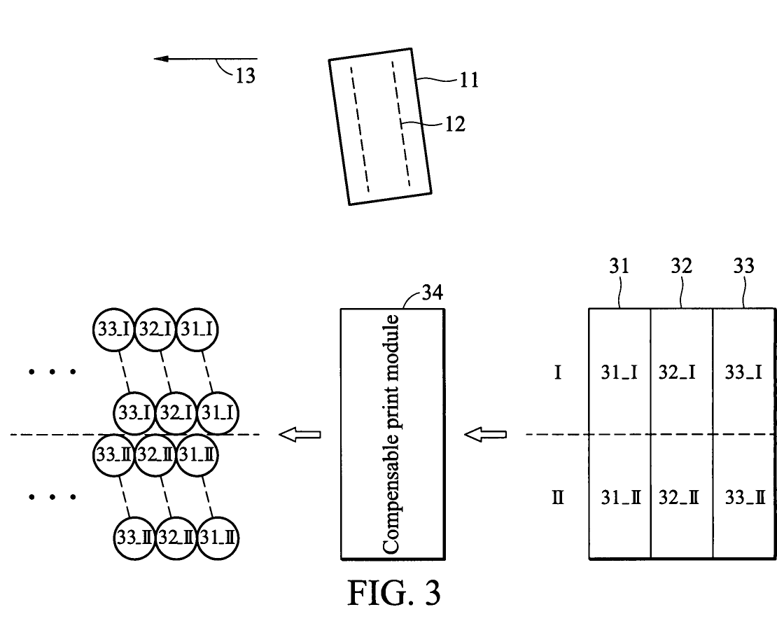

FIG. 3 is a schematic diagram of a method for alignment of the print in FIG. 2 according to embodiments of the invention. The printhead skews to the left and the displacement offset is two dpi. Column data transmitted to the printhead 11 is divided into two sections, section I and section II. The present embodiment uses three successive column reading as an example. Compensable print module 34 receives column data 31, column data 32 and column data 33 and rearranges them. Printhead 11 receives and prints section 32_I of column data 32 and section 31_II of column data 31 in a position pulse and receives and prints section 33_I of column data 33 and section 32_II of column data 32 in the next pulse. Compared with FIG. 2, print misalignment is reduced.

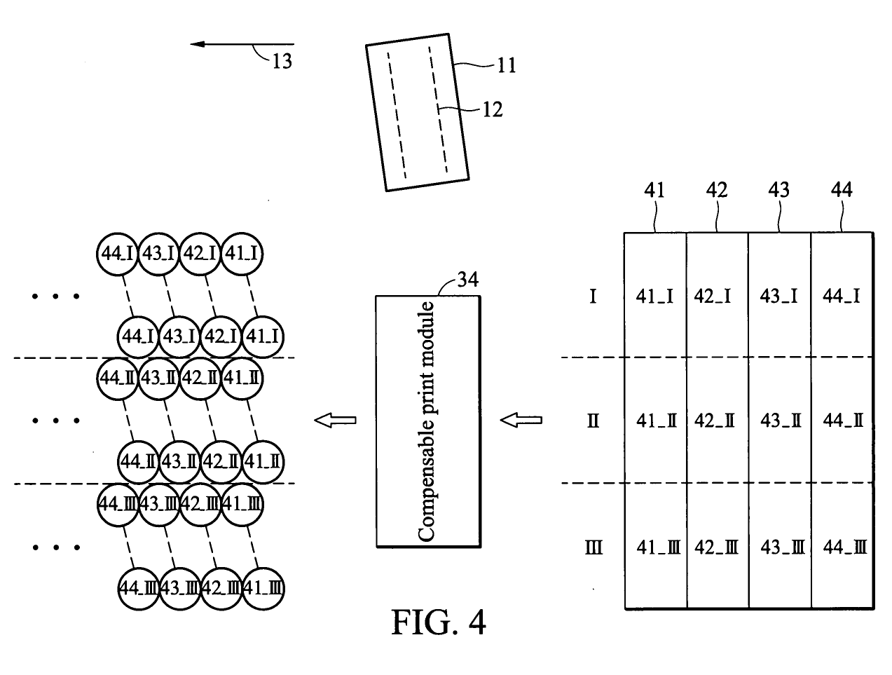

FIG. 4 is a schematic diagram of another method for alignment of the print in FIG. 2 according to embodiments of the invention. When printhead is skewed to the left and the displacement offset is three dpi, column data transmitted to the printhead 11 is divided into three sections, section I, section II and section III. The present embodiment uses four successive column reading as an example. Compensable print module 34 receives column data 41, column data 42, column data 43 and column data 44 and rearranges them. Printhead 11 receives and prints section 43_I of column data 43, section 42_II of column data 42 and section 41_m of column data 41 in a position pulse and receives and prints the section 44_I of column data 44, section 43_II of column data 43 and section 42_II of column data 42 in the next pulse. Compared with FIG. 2, print misalignment is reduced.

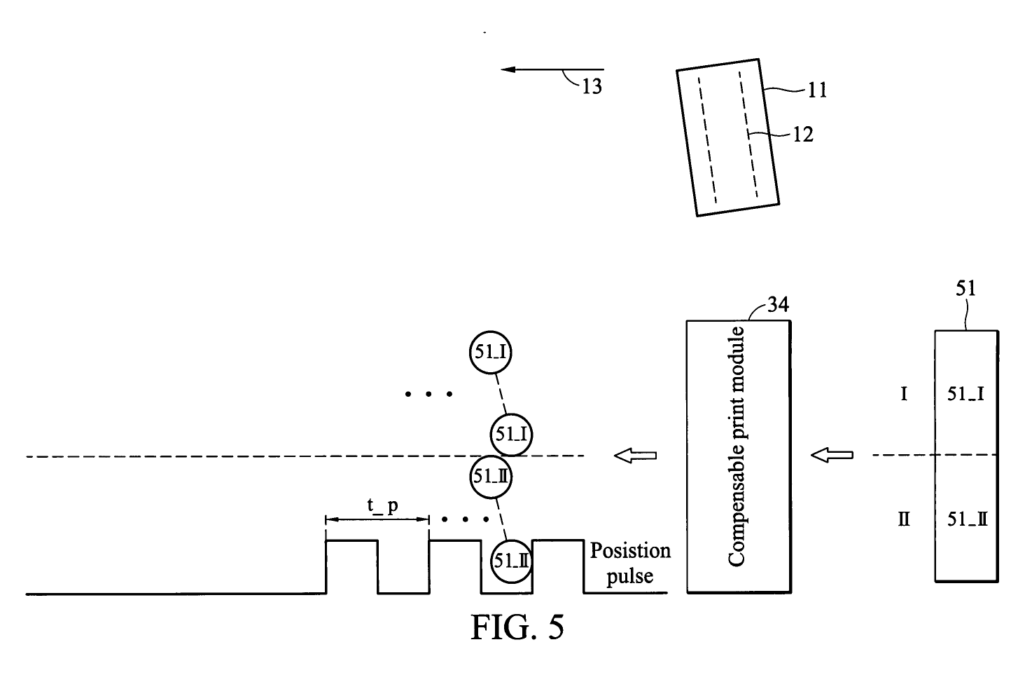

FIG. 5 is a schematic diagram of another method for alignment of the print in FIG. 2 according to embodiments of the invention. When printhead is skewed to the left and the displacement offset is two dpi, the column data transmitted to the printhead 11 is divided into two sections, section I and section II. Compensable print module 34 receives column data 51 and transmits the section 51_I of column data 51 to printhead 11 to print first and then transmits the section 51_II of column data 51 to print. To avoid increasing the total print time, the print time of each section should be equal to or less than (1/2tₚ). Compared with FIG. 2, print misalignment is reduced.

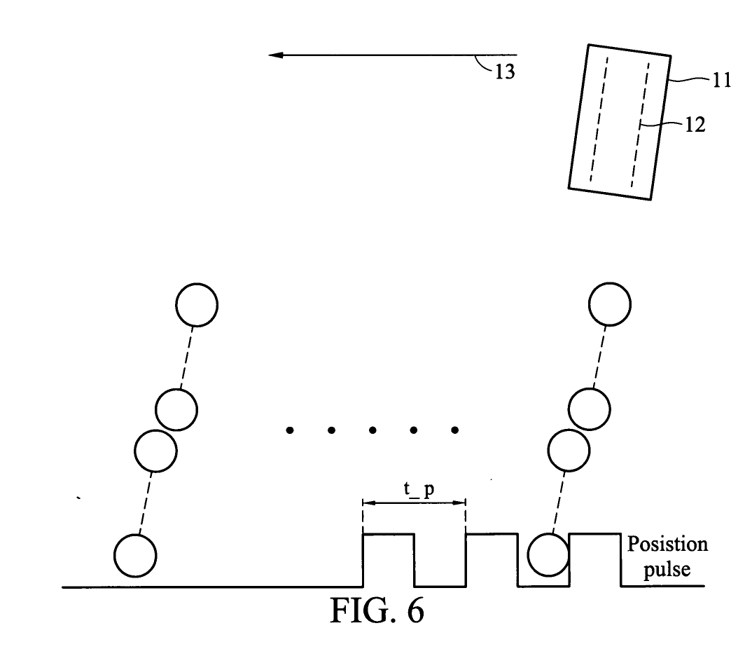

FIG. 6 shows printing when a printhead skews to the right. When each nozzle of column 12 outputs ink in a position pulse, the printing is a straight line skewed to the right.

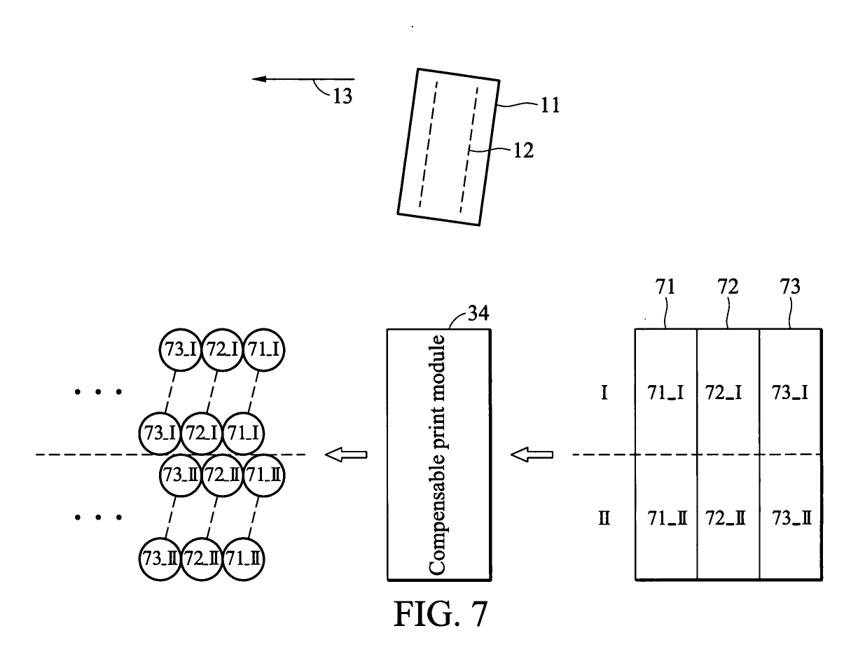

FIG. 7 is a schematic diagram of a method for alignment of the print in FIG. 6 according to embodiments of the invention. The printhead is skewed to the right and the displacement offset is two dpi. The column data transmitted to the printhead 11 is divided into two sections, section I and section II. The present embodiment uses three successive column reading as an example. Compensable print module 34 receives column data 71, column data 72 and column data 73 and rearranges them. Printhead 11 receives and prints section 71_I of column data 71 and section 72_II of column data 72 in a position pulse and receives and prints section 72_I of column data 72 and section 73_II of column data 73 in the next pulse. Compared with FIG. 6, print misalignment is reduced.

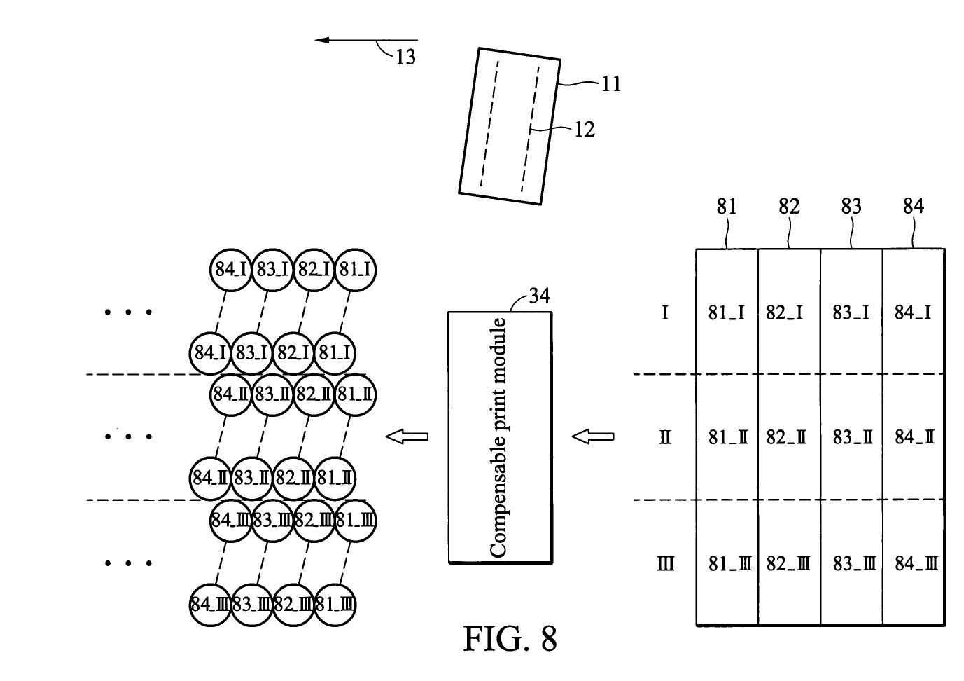

FIG. 8 is a schematic diagram of another method for alignment of the print in FIG. 6 according to embodiments of the invention. When printhead is skewed to the right and the displacement offset is three dpi, column data transmitted to the printhead 11 is divided into three sections, section I section II and section III. The present embodiment uses four successive column reading as an example. Compensable print module 34 receives column data 81, column data 82, column data 83 and column data 84 and rearranges them. Printhead 11 receives and prints section 81_I of column data 81, section 82_II of column data 82 and section 83_III of column data 83 in a position pulse and receives and prints section 82_I of column data 82, section 83_II of column data 83 and section 84_III of column data 84 in the next pulse. Compared with FIG. 6, print misalignment is reduced.

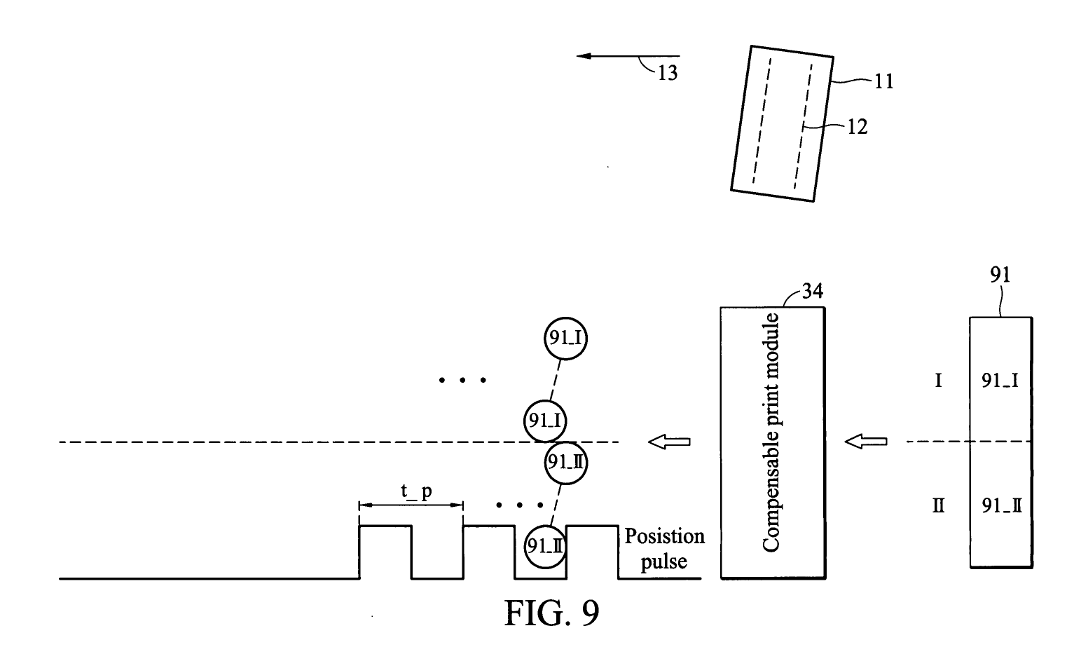

FIG. 9 is a schematic diagram of another method for alignment of the print in FIG. 6 according to another embodiment of the invention. The printhead 11 is skewed to the right and the displacement offset is two dpi. The column data transmitted to the printhead 11 is divided into two sections, section I and section II. Compensable print module 34 receives column data 91 and transmits section 91_II of column data 91 to printhead 11 to print first and then transmits section 91_I of column data 91 to print. To avoid increasing the total print time, the print time of each section should be equal to or less than

$$( \frac{1}{2} {t}_{p} ) .$$

Compared with FIG. 6, print misalignment is reduced.

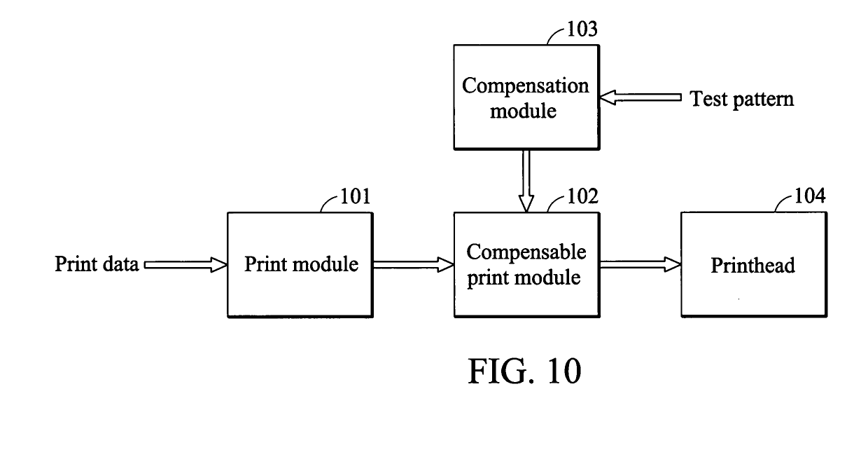

FIG. 10 is a functional block diagram of a system for alignment of print. The print module 101 receives and translates print data into column data. The compensation module 103 receives a test pattern and outputs compensation data, including a skew direction and a displacement offset N for printhead 104. The compensable print module 102 receives and divides the column data from the print module 101 into N sections and executes an alignment procedure. When the printhead 104 is skewed to the right, printhead 104 receives the first section of the first column data, the second section of second column data, the third section of third column data and so on to print. Alternatively, the printhead 104 receives the Nth section of the column data to print and then receives the (N-1)th section of the column data to print and so on in a print period (tₚ). When the printhead 104 is skewed to the left, the printhead 104 receives the Nth section of first column data, the (N-1)th section of second column data, the (N-2)th section of third column data and so on to print. Alternatively, the printhead 104 receives the Nth section of the column data to print and then receives the (N-1) th section of the column data to print and so on in a print period (tₚ).

While the invention has been described by way of example and in terms of preferred embodiment, it is to be understood that the invention is not limited thereto. To the contrary, it is intended to cover various modifications and (as would be apparent to those skilled in the art). Therefore, the scope of the appended claims should be accorded the broadest interpretation so as to encompass all such modifications.

What is claimed is:

1. A print alignment method for a printhead, comprising:
detecting a skew direction of the printhead;
receiving column data corresponding to a plurality of printhead nozzle columns;
dividing column data into N sections;
selecting corresponding N column data;
wherein, when the skew direction is to the right, the printhead receiving the first section of first column data, the second section of second column data, the third section of third column and so on to print; and
when the skew direction is to the left, the printhead receives the Nth section of the first column data, the (N-1)th section of the second column data, the (N-2)th section of the third column data, and so on to print.

2. The method of claim 1, wherein N is larger than or equal to two.

3. The method of claim 1, wherein the step of detection of a skew direction of the printhead further comprises:
receiving and printing a test pattern; and
determining the skew direction of the printhead and a displacement offset in accordance with the printing of the test pattern.

4. The method of claim 3, wherein N is determined in accordance with the displacement offset.

5. The method of claim 1, wherein the printhead nozzles are driven by address signals and primitive select signals and divided into banks by the primitive select signals.

6. The method of claim 5, wherein each section comprises an integer of banks.

7. A print alignment method for a printhead, comprising:
detecting a skew direction of the printhead;
receiving column data corresponding to a plurality of printhead nozzle columns;
dividing column data into N sections;
wherein, when the skew direction is to the left, the printhead receives and prints the first section of the column data and then receives and prints the second section of the column data and so on in a print period(tₚ); and
when the skew direction is to the right, the printhead receives and prints the Nth section of the column data and then receives and prints the (N-1)th section of the column data and so on in a print period(tₚ).

8. The method of claim 7, wherein N is larger than or equal to two.

9. The method of claim 7, wherein the step of detection of a skew direction of the printhead further comprises:
receiving and printing a test pattern; and
determining the skew direction of the printhead and a displacement offset in accordance with the printing of the test pattern.

10. The method of claim 9, wherein N is determined in accordance with the displacement offset.

11. The method of claim 7, wherein the printhead nozzles are driven by address signals and primitive select signals and divided into banks by primitive select signals.

12. The method of claim 11, wherein each section comprises an integer of banks.

13. The method of claim 7, wherein the print time of each section of the column data is less than or equal to
$$( \frac{1}{N} {t}_{p} ) .$$

14. A print alignment system for a printhead, comprising:
a print module receiving print data and translating it into column data, corresponding to a plurality of printhead nozzle columns;
a compensation module receiving a test pattern and outputting compensation data, wherein the compensation data comprises a skew direction and a displacement offset;
a compensation print module executing a print alignment procedure in accordance with the column data and the compensation data, comprising:
dividing column data into N sections;
selecting corresponding N column data;
wherein, when the skew direction is to the right, the printhead receiving the first section of first column data, the second section of second column data, the third section of third column and so on to print; and
when the skew direction is to the left, the printhead receives the Nth section of the first column data, the (N-1)th section of the second column data, the (N-2)th section of the third column data, and so on to print.

15. The system of claim 14, wherein N is larger than or equal to two.

16. The system of claim 14, wherein N is determined in accordance with the displacement offset.

17. The system of claim 14, wherein printhead nozzles are driven by address signals and primitive select signals and divided into banks by primitive select signals.

18. The system of claim 17, wherein each section comprises an integer of banks.

19. A print alignment system for a printhead, comprising:
a print module receiving print data and translating it into column data, corresponding to a plurality of printhead nozzle columns;
a compensation module receiving a test pattern and outputting compensation data, wherein the compensation data comprises a skew direction and a displacement offset;
a compensation print module executing a print alignment procedure in accordance with the column data and the compensation data, comprising:
dividing column data into N sections;
wherein, when the skew direction is to the left, the printhead receives and prints the first section of the column data and then receives and prints the second section of the column data and so on in a print period(tₚ); and
when the skew direction is to the right, the printhead receives and prints the Nth section of the column data and then receives and prints the (N-1)th section of the column data and so on in a print period(tₚ).

20. The system of claim 19, wherein N is larger than or equal to two.

21. The system of claim 19, wherein N is determined in accordance with the displacement offset.

22. The system of claim 19, wherein the printhead nozzles are driven by address signals and primitive select signals and divided into banks by primitive select signals.

23. The system of claim 22, wherein each section comprises an integer of banks.

24. The system of claim 19, wherein the print time of each section of the column data is less than or equal to
$$( \frac{1}{N} {t}_{p} ) .$$
